(19) United States
(12) Patent Application Publication
(10) Pub. No.: US 2004/0068490 A1
(43) Pub. Date: Apr. 8, 2004

(54) System and method for providing advisory services

(76) Inventors: Alan Guibord, Southport, CT (US); Ronald D. Leong, Westport, CT (US)

Correspondence Address: William J. Sapone, Esq., Coleman Sudol Sapone P.C., 714 Colorado Ave., Bridgeport, CT, 06605, US

(21) Appl. No.: 10/266,073

(22) Filed: Oct. 7, 2002

(51) Int. Cl. G06F 7/00

(52) U.S. Cl. 707/3

(57) ABSTRACT

A computer based advisory system accepts queries from users needing advice on diverse areas, such as information technology, market research, etc, preferably via an internet portal, and uses an accumulated knowledge database to search for resources for generating responsive advice, assigning the resources, providing a flexible electronic workspace for facilitating the development of reports, monitoring the advice generation process and for delivering the responsive advice to the user in a timely and cost effective manner.

### TECHNICAL FIELD

This invention relates to a computer based system for providing advisory services which includes but is not limited to collecting, categorizing, synthesizing and/or disseminating requested information to a business in a cost effective manner.

### BACKGROUND

To grow and develop, many businesses must occasionally utilize outside services and personnel such as consultants or information service providers to provide specialized information, research and counseling. For example, a company planning to upgrade its computer hardware or software systems may lack the expertise to analyze available systems for their particular use, and often, relying on vendor recommendations, can incur unforeseen expenses or difficulties. In other instances, a company may need targeted information, such as a market analysis for a new or existing product, but be unable to obtain quality information in a timely manner.

It can also be difficult for a business to identify and select an appropriate consultant, as the lack of specialized knowledge in house makes it difficult to assure that the consultant chosen is up to the assigned task, and once chosen, that the work being performed is proceeding in the most cost effective manner. Accountability is particular problem, as a consultant may accept more work than can be handled in the time needed by the client, or, alternatively, having little other work, may exceed specified activities on the project, increasing costs.

On the other hand, there are many consultants and researchers with specialized knowledge or skills who may be limited in their ability to market their services or to locate customers who are a true match to their specialty, as these generally tend to be small firms, groups or individuals in diverse locations.

On large projects, the business may be able to use a large service firm, but many companies, particularly small companies with limited resources, may have relatively simple research projects, that should take no more than one or two days to complete but which cannot be obtained, as such small projects are not profitable for many service providers and even if accepted, have a low priority and so are typically not completed in a timely manner.

What is needed is a computer based advisory system that addresses these problems by providing companies with synthesized, relevant information and counsel, coupled with ready access to consultants, researchers and other resources, previously qualified and available for immediate response, and who are matched to their specific needs.

### SUMMARY OF THE INVENTION

It is an object of the present invention to provide a computer based advisory system available to a user seeking advisory services, the system having at least one database containing data on knowledge resources, such as researchers, consultants, information providers, accumulated research material, etc., means to receive a query from the user, means to analyze the query, means to search and select the knowledge resources for responding to the query, means to engage the resources and to generate a response for delivery to the user. The advisory system incorporates a qualification and search component for building the knowledge database, allowing the business to focus solely on the information needed, and allowing the advisory system to accept the task of locating, qualifying and assigning the necessary resources. Preferably, the advisory system has means for monitoring progress and for providing a quality review of the response prior to delivery to the user.

Preferably, the advisory system is engaged via an internet web site, provided as the portal for access by various users, such as a small business seeking advice on a software development project. An input screen displayed on the users' local terminal enables a query to be generated which is received by the system and preferably transmitted to an administrator. Separately, a database of knowledge resources is maintained, including information on available consultants, researchers, information providers and other resources qualified at least as to their quality, availability and content. The advisory system analyses the query and searches the database to select the resources most closely aligned to the users' query, for use in generating the query response.

The query is analyzed and qualified for taxonomy and metadata for use in searching one or more databases to identify the appropriate resources. This may initiate a research query which is generated for contacting for example a researcher to determine availability for the project, which preferably is sent via email. After a response is received, the administrator or an advisor selected automatically by the system or assigned by the administrator, is notified and confirms the selection of the resources to be used, issues the assignment and then monitors progress. A response to the users' query is then generated and sent to the administrator or advisor and reviewed for quality and completeness. The response may be modified during the review or returned for revision if necessary. The response is then delivered to the user.

Using the present invention, businesses are freed from having to locate specialized resources and from qualifying the resources, as the advisory system assures proper matching to the needs of the business. Similarly, consultants, researchers and service providers in diverse locations are able to expand their client base, as they are given assignments suitable to their specialized skills or talents, and tailored to their availability. The result is enhanced quality of services, timeliness of response and avoidance of unnecessary cost and expense.

### BRIEF DESCRIPTION OF THE DRAWINGS

FIG. 1 is an overview of one embodiment of the advisory system of the present invention.

FIGS. 2-23 are details of specific process flows in accordance with the present invention.

FIGS. 24-30 are illustrative displays generated by the advisory system.

### DETAILED DESCRIPTION OF THE INVENTION

The invention is an advisory system, preferably web based, that enables matching a business's needs for research, information and/or project management with competent resources to provide advice on request to the business, the system preferably utilizing a computer based electronic workspace to facilitate the researching and development of reports and content. The advice can relate to many areas, including but not limited to manufacturing, marketing, system improvements and upgrades, competitive intelligence, etc, but is particularly useful for assistance with information technology, encompassing computer hardware and software systems, as it is difficult for a small company to have expertise in this rapidly changing field. The inventive system acts as a central clearing house having access to qualified resources, assuring quality of the services provided, as well as timeliness of the advice, delivered in a cost effective manner.

The system is preferably query driven, that is, the client defines the problem to be addressed or project to be completed. This may include many different areas, from market research on a particular product, qualifying computer systems or software prior to purchase, etc., with the system designed to grow dynamically in capability based on the scope and content of the search requests. As requests come in for specific topics, resources are identified from an existing database or by a search for new resources which are then added to the database. The requests and responses may be stored in a searchable database for future reference, and so the system will grow in its knowledge and resource base over time, increasing the value to clients of the system. The system supports individualized computer based electronic workspaces that allow advisors and researchers to collect and synthesize information, and develop reports on queries to be reviewed by the company for dissemination to clients making the query. Preferably, the system utilizes computers for electronic communication, analysis and storage of data, providing ready access via the internet to clients and to matched resources.

A server is used to support communication via the internet. One or more administrators would control the system from an administration terminal. This terminal would allow monitoring and control of all activities in the advisory system.

The administrator or an assigned advisor would review input from clients, preferably in the form of a query, monitor the computer analysis of the query and the search for needed resources, receive and review the output from the analysis, enable communication with selected resources and monitor for acceptance, supervise the transfer of the query to the resources, monitor progress, and then receive, review and approve the response prior to transmission to the client.

Preferably, the advisory system is provided on a subscription basis which provides access to the system over a given time period, which may include in the subscription price, prepayment for responses to one or more queries, or provide access based on a block number of prepaid queries. This simplifies the processing of requests for advice and eases use by subscribers to the system. For example, once subscribed, the user can have an icon on their local terminal for immediate access to the system for formulating a query, their saved subscription information avoiding delays by being readily available to the administrator or advisor for initiating a response.

Initially, the system may be configured to provide two standardized types of responses, one being a quick response, limited in scope and content, being in the nature of a screening type of response so the user can determine if the initial query was appropriate to the information sought or where a brief low-cost response is desired. This may be referred to herein as a “QAR”. The second standardized type of response would be more comprehensive, more detailed and include more research and use of resources. This response is generated when the user requires such detailed information, for example, on important market research needed to guide a substantial company expenditure. This more comprehensive response may be referred to herein as a “CAR”. In either case, pricing of the subscription can include one or more QAR=s or CAR's, with additional QAR's or CAR's generated as an add-on charge payable on delivery.

The following is a more detailed description of the invention.

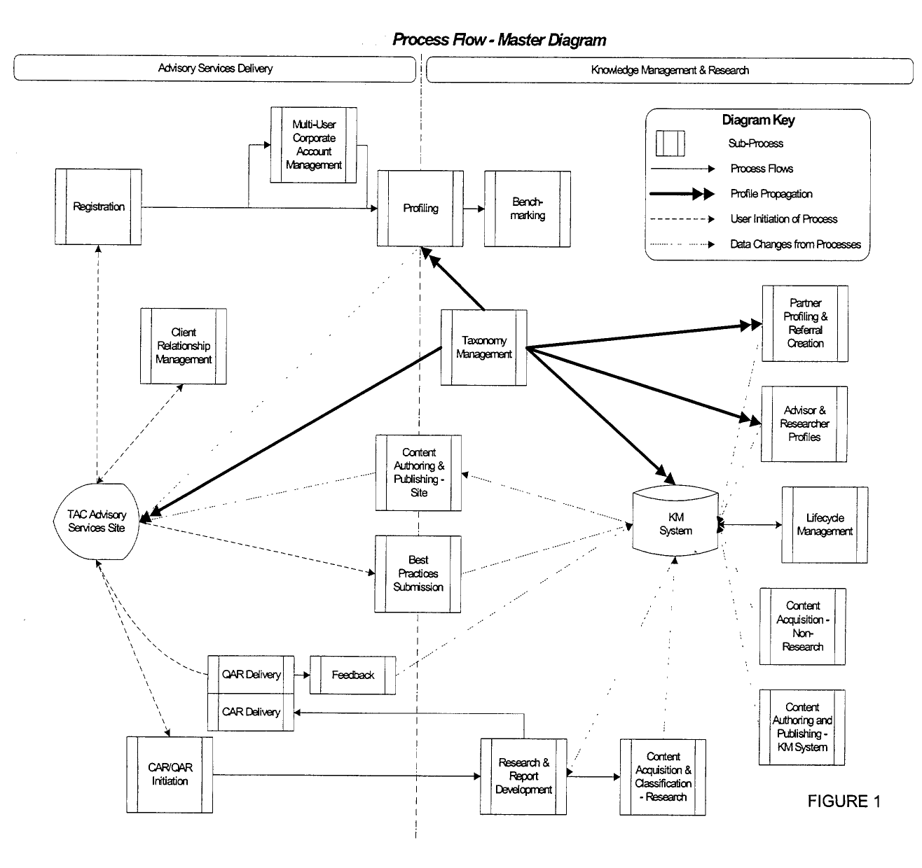

Referring to FIG. 1, an overview of an advisory system according to the present invention is shown. The system comprises two components, one component relates to advisory services delivery to users. This is where user intake, interaction and advice delivery occurs. In essence this is the client side of the system. The second component is related to knowledge management and research, where the user query is analyzed, resources identified and matched to the query, and the response generated. This is the administration side of the system. The individual modules referred to will be described in more detail below.

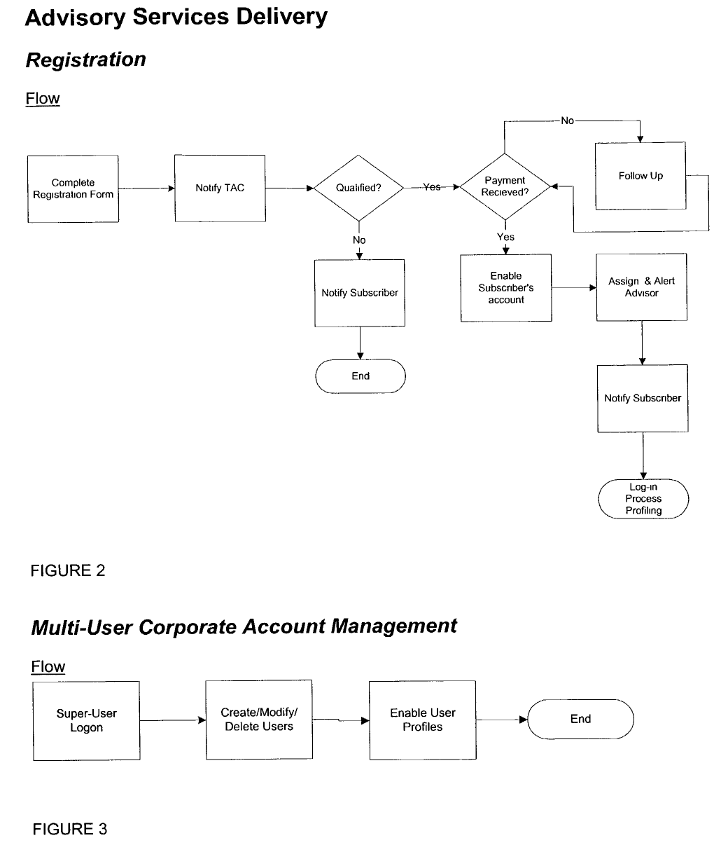

With reference to FIG. 2, the potential user or client completes a registration form that includes contact information, payment information (including payment preferences for add-on services), and enough user profile information for the system or administrator to make any initial determination as to whether the user is qualified to participate in the advisory system.

The administrator, which may be referred to as TAC, is notified that a potential client has registered, and using the registration information, the administrator determines whether the potential client is qualified. This may include whether the client is a company or individual, the area they are seeking advice in, industry, financial strength, etc.

If the potential client is not qualified, they are notified and are provided with a brief explanation for their disqualification. For example, portions of the registration form may have been left blank, were incomplete, or appeared to include incorrect information. The potential client may be given an opportunity to correct the registration form.

The administrator may take steps to ensure that the payment mechanism specified by the client is valid and complete. For certain types of payments, e.g. credit card or electronic funds transfer, the administrator may wish to validate that the transaction is complete before continuing. As described above, the system may operate on a subscription basis, so that a user has access to the advisory system for a defined period or for a defined number of tasks. If so, the client pays a subscription fee prior to using the system. If payment is received, the administrator enables the subscriber=s account on the system. If payment has been completed, the user will be able to submit a query. If payment has been specified but not completed, the user may only have limited access to the system.

In one embodiment of the invention, the administrator identifies and assigns an advisor to the subscriber. One or more advisors having particular areas of expertise may be prequalified by the administrator and available via the internet for assignment to particular clients. The advisor is the primary contact with the assigned client and manages the clients' interaction with the system. The administrator alerts the selected advisor that they have a new subscriber. The subscriber then receives a “Welcome to the Advisory System” notification that includes all of the pertinent information regarding their subscription, and with the completion of this process, login is enabled for the subscriber. At that point, the advisor initiates a profiling process.

In an additional embodiment of the invention (FIG. 3), a group or corporate type of account can be created to allow multiple users to use the system through a single account that provides aggregated reporting and administration of the users.

The advisor preferably monitors all projects for the assigned client, though the advisor may seek assistance from another advisor when additional expertise is required. If an advisor is unavailable, the system may assign the client to another advisor, or initially may designate primary and secondary advisors so that back-up support is immediately available if a primary advisor is unavailable. While the subscriber may be notified as to who they have as an advisor, they need not have contact with a specific advisor, with all communication routed through the administrator in which case any available advisor could be assigned without notifying the subscriber of that fact. Also, advisor assignments can be re-evaluated after the profiling process is complete to better align with user requirements.

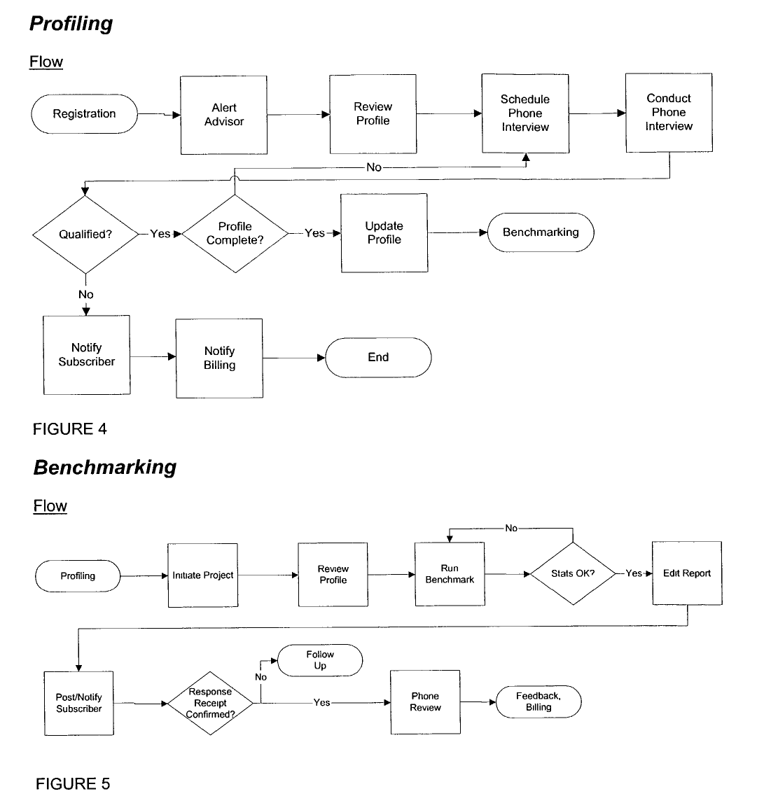

With reference to FIG. 4, a client profile is prepared to obtain information that will be readily available for use when a query is received. This is initiated by the registration process, where the client includes preliminary information on the registration form. A more detailed intake prior to or during registration should be avoided to facilitate registration. Once registered, the subscriber is prompted to complete a detailed profile via a display with fields for completion.

The assigned advisor then undertakes a profile review. The system notifies the advisor when the profile has been completed or if it is updated in the future or if a specified time has elapsed without the profile having been completed, in which case, the advisor may contact the subscriber to urge the subscriber to fill out the profile. After completing the profile fields, the advisor reviews the profile and may add comments for future reference, or may contact the subscriber to review and clarify the profile. This can be done by phone, or via email.

The advisor may assist the subscriber in completing any missing elements, and there may be elements of the profile that call for a judgment of the advisor, e.g. a risk profile or level of sophistication of the subscriber, that can be completed after review and/or discussions with the user. When completed, the profile information is saved and compiled in a database that will include information from other clients. The next step may be to create a benchmark report. The benchmark report may be an optional add-on item beyond the user=s subscription, or be offered as a paid service to subscribers.

Referring to FIG. 5, the profile is reviewed by the system and compared to a database of other subscribers. From this a benchmark report can be generated showing where the user is ranked relative to the other subscribers. The benchmarking report may include, but is not limited to, information on company revenue, number of employees, size of departments, organizational information, information relating to its systems infrastructure and departmental spending. The benchmarking report is preferably delivered in a My Advice area of the users' web site portal, which is an individualized electronic workspace supported by the system for display on the clients' local terminal. A confirmation is sent to the advisory system when received. If no confirmation is received, the advisor is prompted to contact the subscriber to follow up and offer to review the benchmark report with them. The benchmark report is followed up by the advisor with a feedback contact to the subscriber.

Initially, benchmarks will be constrained to benchmarking against the entire universe of subscribers. More specific benchmarks will be enabled as a statistically significant population of a subset becomes available, which is likely to be by size of company or by industry.

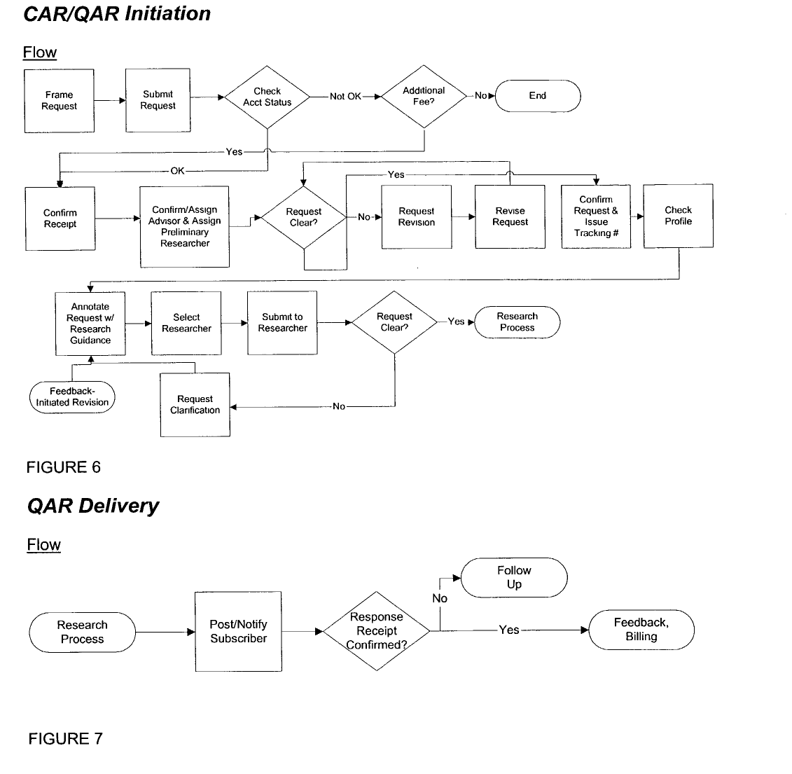

With reference to FIG. 6, the subscriber seeking advice must first develop a request. The system provides a form and guidance to help the user differentiate between the types of reports available for formulating the response to the query. These may be the quick report (QAR) or the more detailed report (CAR), described above. The system ensures that the user provides sufficient information about the project in the request to proceed.

The subscriber then submits the request to the system. The system performs a check of the status of the account, to ensure that the report requested is supported by their subscription or by some form of pre-approval, such as a blanket purchase order, that ensures that the subscriber has a mechanism in place to pay for the project.

If the account status indicates that no agreement for payment is in place, the system provides the user an opportunity to arrange payment for the project. This could be through taking a credit card number, allowing a PO number to be provided, etc. The actual mechanism may vary. If the client chooses to decline providing a new form of payment, the process will not proceed.

Once the system has validated the account status, an automatic confirmation is provided to the subscriber indicating that the system has received their project request and the financial impact of that request, e.g. “your credit card will be charged $500 in addition to your monthly subscription charge” or “A QAR will be deducted from your subscription balance. You have one remaining QAR for the remainder of your subscription. Additional QARs may be purchased for $500 each.”

The system will assign an advisor to the project. The system will first assess the availability of the subscriber=s assigned advisor. If that advisor is unavailable, either due to vacation, workload, etc., the system will assign a backup advisor. In addition, the system may assign a preliminary researcher to assist in the validation/clarification of the question, particularly in areas where the advisor may not have expertise.

The advisor and preliminary researcher will review the project request for clarity, in order to ensure a focused and useful response can be provided. If the request is not clear, the advisor will return the request to the subscriber with a specific request for clarification, with guidance or perhaps alternative routes to answer the question specified. This could take place in a number of fashions—via telephone, e-mail, or via an instant message exchange on the system. In any of these cases, the advisor documents the interaction with the subscriber. This documentation serves as an audit trail should the subscriber have a complaint or issue with the service provided. In addition, this documentation may be provided to the researcher to ensure that they understand the scope of the request and can prepare a targeted response. Once the subscriber has responded to the request for revision, clarifying the project, the system provides a final confirmation of the request that details the revised request (if appropriate), provides a tracking number, and indicates the due date/time for the request. This will confirm the scope and timing of the request. Preferably, the project will now appear with its status in a My Advice section of the site for the subscriber.

The advisor checks the subscriber=s profile to determine if there is any additional guidance they can extract from the profile, and the advisor may add their own insights into avenues of research or issues that the researcher should pursue. The system will search the available databases to select a researcher, based on their skill sets and availability. This may be the same researcher who reviewed the request, or it may change based on expertise and availability. The system will submit the request, accompanied by the advisor=s notes and documentation of any clarification exchange with the subscriber to the researcher. The researcher will review the request to determine if they have sufficient information and understanding to proceed with responding to the request. If the request is unclear, the researcher may request clarification from the advisor. Preferably, an audit trail of this classification process will also be captured to ensure the best response is created. In addition, it may be possible to leverage the request form and the clarifying material by extracting data to pre-populate a search form for the research process.

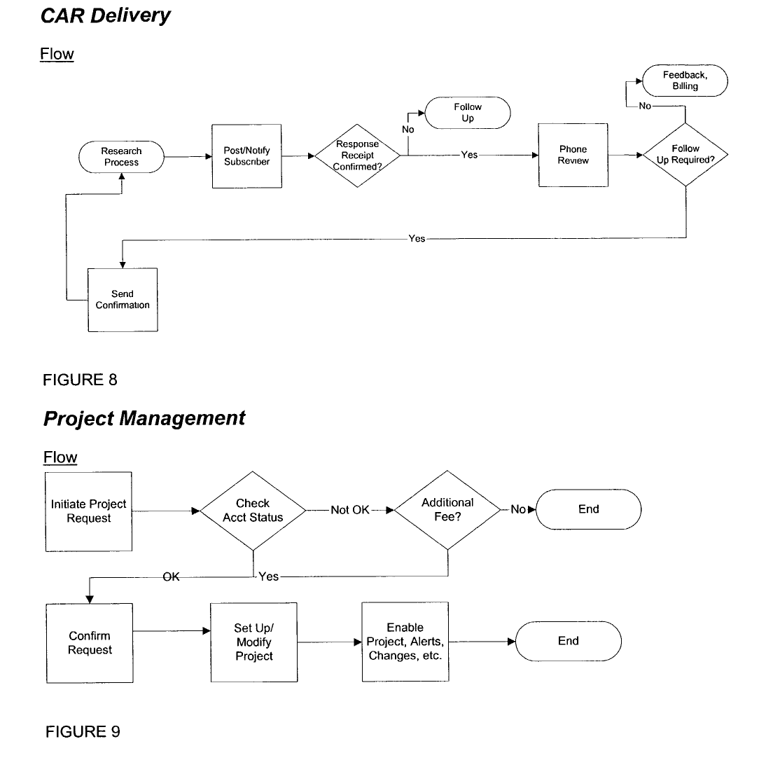

Referring to FIGS. 7 and 8, the delivery process is initiated after completion of the research and review process, which will be described below. The research report is posted to the subscriber's “My Advice” area and the subscriber is notified. When the subscriber views for example a QAR report in their My Advice area, a confirmation is sent to the system. If no confirmation is received, the advisor is prompted to contact the subscriber to follow up and remind them that their response has been posted. The QAR is followed up with a feedback contact to the subscriber and an update to the account to indicate that the QAR is completed, and to indicated a billing event if appropriate.

After a confirmation is received, the advisor may additionally schedule and conduct a phone review of the report content with the user. The advisor may discuss areas for additional or follow-on projects, but primarily should ensure that the subscriber is satisfied with the report received. If there is an item that the advisor agrees is missing from the report, it may be determined that follow-up research is required. A confirmation will be sent to the subscriber and the research process will be re-initiated at the point the advisor annotates in the request to the researcher. The original request and response will be included. Once no follow-up research is required, the process proceeds to feedback and billing.

With reference to FIG. 9, the subscriber may indicate they would like to set up a project for project management. The system performs a check of the status of the account, to ensure that their subscription allows this feature or some form of pre-approval, such as a blanket PO, is in place that ensures that the subscriber has a mechanism in place to pay for the project management. If the account status indicates that no agreement for payment is already in place, the system will provide an opportunity to provide payment for the project management. This could be through taking a credit card number, allowing a PO number to be provided, etc. If the client chooses to decline providing a new form of payment, the process will not proceed.

Once the system has validated the account status, a confirmation will be provided to the subscriber indicating that their project request was received and the financial impact of that request, e.g. “your credit card will be charged $500 in addition to your monthly subscription charge”. The subscriber sets up the project parameters—schedule, tasks, etc. They may later modify these items. The system enables the project and incorporates alerts into the system. This process is completed by engaging the task/alert system and enabling ongoing subscriber access to modify the project.

Feedback is an important component of the system. User feedback can be used to assure the quality and timeliness of the utilized resources. For example, the subscriber may provide ratings feedback, which can be attached to the database information for the appropriate resource, available the next time the resource may be selected by the system.

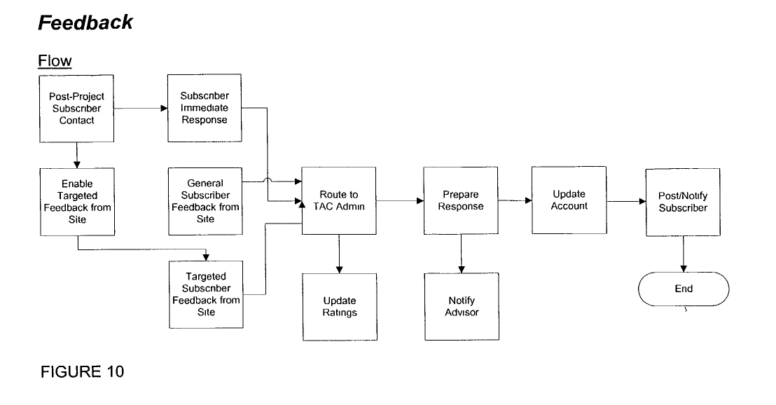

With reference to FIG. 10, one point of initiation for subscriber feedback is when a project or other services have been completed. When such an event occurs, the subscriber may be contacted to provide feedback on that service event. This may take place via an alert, e-mail, phone, etc. The subscriber may at any time provide feedback on any content or referrals included in the project. This enables the system to capture both the immediate reaction to the service as well as the level of satisfaction once the subscriber has had an opportunity to read the content or use the referrals. Any subscriber feedback is routed to the appropriate administrator or advisor.

All feedback received from subscribers generates an acknowledgment back to the subscriber. This may be a stock acknowledgment for simple or positive feedback, or other feedback that requires no specific action. For feedback that requires action, such as a complaint or a question about using the service, the system may use keywords for preparing a targeted response. Over time, service-related questions of general use can be posted as FAQs on the site.

In some instances, the administrator may receive a comment or complaint that warrants providing the subscriber with compensation. The subscriber's account balance may be adjusted to provide a credit or one or more free additional reports. In any event, the feedback and response are recorded in the subscriber=s account history.

### Knowledge Management & Research

### Research & Report Development

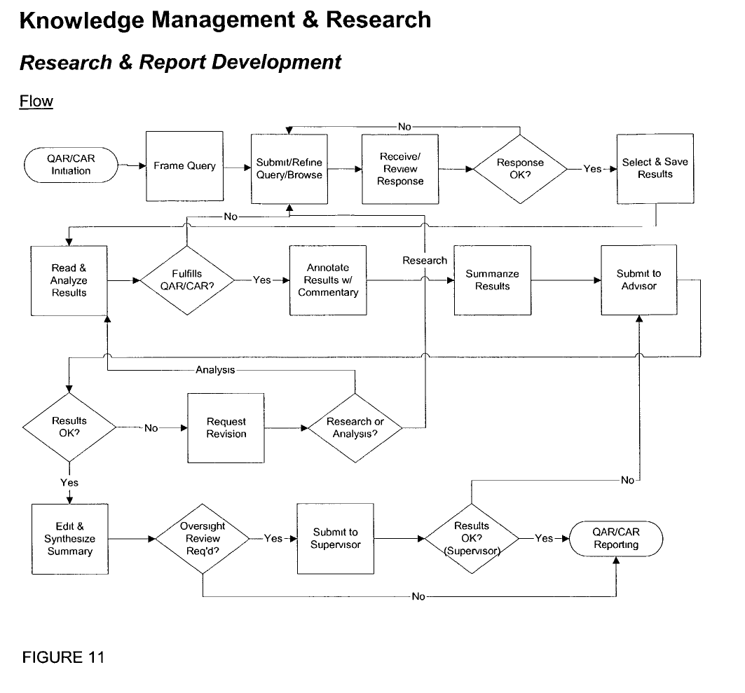

With reference to FIG. 11, based upon a researcher=s understanding of the request, an appropriate search query is devised. To the extent possible, the query may leverage information captured in the request form that is refined through the exchanges between the subscriber, advisor, and researcher. At this point, the researcher may reference the profile, in read-only mode. The advisor may also restrict access to portions of the profile.

The researcher submits the search query to the system to begin the search. when the results are received, the researcher may determine that the query needs to be refined if the response did not fulfill their needs. In addition to submitting a structured query, the researcher may also browse the knowledge database to find useful content.

The researcher works through an individualized electronic workspace supported by the computer based advisory system. The electronic workspace is displayed at the local researchers or advisors terminal and is user configurable to provide links to selected resources frequently used by the researcher or advisor, as well as access by links to web pages having details of the projects assigned, progress to date, time remaining, etc. It also has means for communication between the administrator, advisor and researcher, as well as convenient access to stored information and files. The electronic workspace is where the synthesizing and report compilation function are completed.

The researcher reviews the system generated response to the query, which may contain content from a number of different categories including documents, events, referrals, previous project reports, and previous project work spaces. The content is tagged as to type in order to facilitate inclusion in the appropriate category within a response template provided to the researcher within the system workspace.

If the initial search results from their query do not fulfill their needs, the query is revised and resubmitted. The researcher reviews primarily content summaries, marking and saving those content items that may be useful. The research may go through multiple iterations of searching/browsing and selecting items for further review. The researcher may want to save content items of value to the project that they are currently working on or because they have value to another project that is either their own or that of another researcher.

The researcher then reviews the saved results, reads through them and analyzes whether they are sufficient to fulfill the request. If the researcher determines that the results do fulfill the request, they proceed to annotate and summarize the results. If not, the query is revised and resubmitted again.

Working in the system workspace, the researcher annotates the selected results as appropriate based upon their own experiences or thoughts, which may include notes or highlights to assist them in preparing a summary or for future reference when they access the content again. The notes may be saved for reference by other researchers using the content in the future, though the notes may be specifically addressed to the client regarding how to interpret the content or any limitations on how to use the content. In addition, the researcher may rate the content as to its usefulness and value, or refine the categorization/classification of the content, for future reference, as this process and the materials are stored on the system. Again, the system is dynamic and will evolve over time as more research projects are initiated and completed.

The researcher summarizes the results, selecting content to insert in designated fields in the response template, as well as creating a draft written summary of the results. Content selected for inclusion in the report may be automatically transferred to the appropriate section based on content type, e.g. referral or event, to the extent possible to facilitate rapid response. From an ease-of-use perspective, the subscriber should have ready access to the content items and the researcher should include hyperlinks to the source materials in the report. The researcher then submits the completed response template to the advisor.

The advisor reviews the summarized results from the researcher and determines whether they adequately fulfill the requirements of the project (QAR/CAR.) If they do, the advisor may optionally edit slightly, or add an additional summary to the report and proceed to the delivery process. If the results are not adequate, a request for a revision is made to the researcher.

Using the system workspace, the advisor has the opportunity to edit the report and adds any additional summary information based upon their knowledge of the specific client or their overall knowledge/experience. If the advisor requests a revision, the researcher reviews the revision request from the advisor and determines whether or not more research will be required or whether the report simply requires more analysis work. If more research is required, they refine the query and repeat the above described steps in the process. If only additional analysis is required, they make the appropriate revisions and submit the results back to the advisor.

Based on the work flow or the roles of the researcher/advisor, there may be a supervisory review of the response prior to delivery to the client. If the response is submitted to the supervisor for review, and if the supervisor approves the response, it continues to the delivery process. If the supervisor rejects the response, it is returned to the advisor. The advisor then reviews the information to determine whether they need additional research or to revise the summary.

Most projects would be limited in scope so as to only require one researcher and therefore, do not require complex project management tools to manage them. The primary tools for managing such projects are status and expected time of completion. The system is adapted to incorporate such tools, though it also offers a full suite of project management tools, as required by the project and accepted as to cost by the user. Interaction between the researcher and advisor in the revision process are captured and interactions as to specific content items are logged (i.e. who annotated and when.)

As discussed above, the researcher may have limited access to the subscriber profile information. The system provides the capability to set permissions for viewing the profile, so that specific levels of permission must be met for viewing some or all of the profile. For example, the identity of the client may be kept as confidential.

The researcher is provided with an electronic work space on the system, accessible via appropriate displays presented on the researchers' computer terminal, where the researcher is able to save search criteria or results, as well as work in progress and draft responses. The system provides a similar electronic work space for the subscriber, as a My Advice display on there local computer terminal, for their reports, queries, and links to relevant resources. The system saves these materials in a way that users and researchers may break from their work and later return to the break point, as if still in progress.

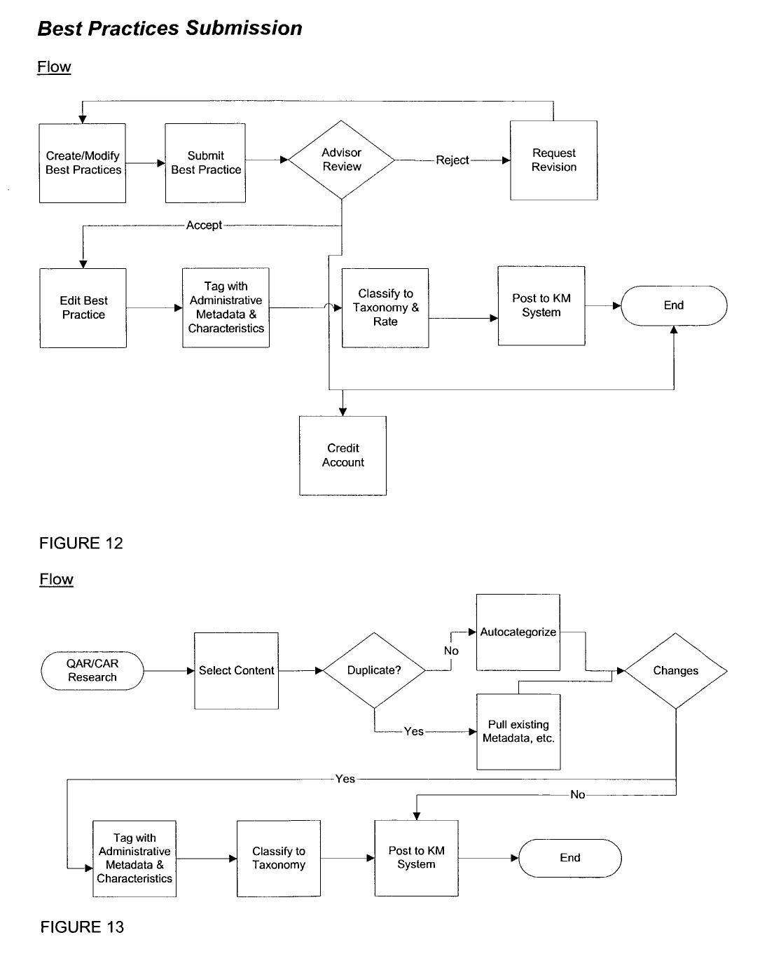

Referring to FIG. 12, the subscriber may be prompted to create a document describing a best practice or particular specification that may be of use to others in the field. Such best practices can be incorporated in the knowledge base and be useful in formulating responses to specific queries. The motivation is to have access to the best practice protocols for formulating responses to their queries. Typically, a subscriber submits the document to the system through their advisor. The advisor reviews the document and determines whether it meets necessary system guidelines for incorporation in the database. If it does, the advisor accept the document and formats it for entry into the knowledge management system. If compensation is used to promote submissions, the subscriber account receives an appropriate credit. If it does not meet the guidelines, the advisor rejects the document and may send the subscriber a revision request explaining why the submission does not meet the required guidelines optionally with suggestions to modify the submission.

The advisor edits the document to assure that it is usable and easily understood, and tags the content with metadata such as author and date created. They will also indicate the type of content, and classify the document according to the system taxonomy for ease in retrieval. The advisor may rate the content with regard to its value. Once saved, the best practice is retrieved during searches with the appropriate parameters.

The advisory system monitors the subscriber/user community for best practices and potentially extracts ideas through the course of the benchmarking process.

Content acquisition and classification is an important component of the advisory system. With reference to FIG. 13, the researcher selects content to be included in the knowledge management (“KM”) database identified during the searching and browsing process. This selection may be directed by a save command, or indirectly occur by the simple action of selecting content for review in their work space. The system checks the metadata to see whether or not this piece of content is already in the system to avoid duplication. If a new item, the system auto-categorizes for the metadata and taxonomy.

The researcher may indicate whether or not they wish to make changes to the content information. If not, the content is stored in the KM system. The researcher tags the content with administrative metadata, indicates what type of content it is, and rates the content with regard to its usefulness and value.

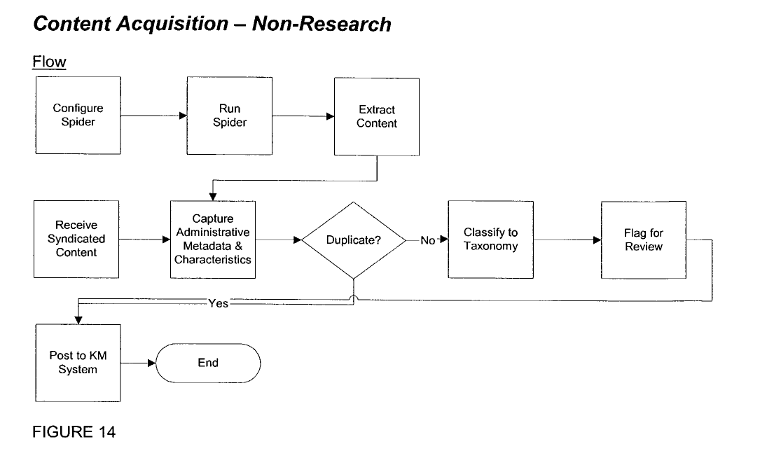

With reference to FIG. 14, content can also be obtained from information providers on a contract or syndicated basis, where the system may search and retrieve content directly for incorporation in the KM database. The content from such parties is received and proceeds directly to a review to capture administrative metadata and characteristics. Alternatively, a researcher may configure a search program, often referred to as a “web crawler” or “spider” to retrieve content that meets specified search parameters, provided the advisory system has an agreement which permits this or where the content is freely available on the Internet. The content located is extracted from the source and saved in the KM system, after the automatic capture of the administrative metadata and characteristics, including the source that it was extracted from.

Using the metadata and characteristics, the system check whether the content already exists in the system. If it is a duplicate the process will end. If not, the system posts the content to the KM system. The content is classified according to the taxonomy hierarchy so that it can be retrieved using the appropriate search parameters.

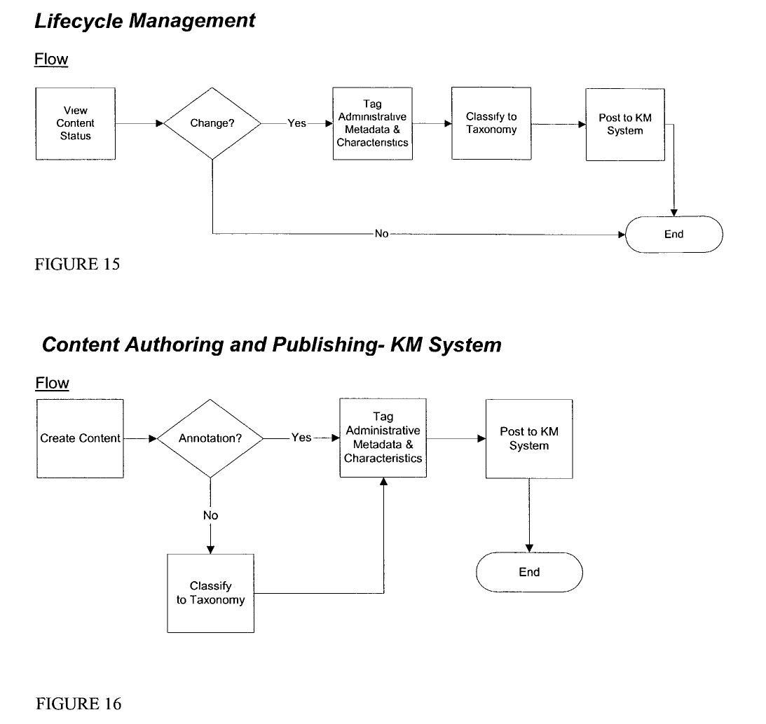

With reference to FIG. 15, the administrator is responsible for the oversight of the KM system, and may search the KM content based on status. Status can include:

Flagged for review/unapproved—any piece of content that has never been used could be considered unapproved.

Approved—has been used or explicitly approved by a user.

Stale—this indicates that the content is old, but may still have some value.

Expired—when the content is acquired it may be tagged with an estimated expiration date at which point the content is presumed to lose its value. Content with a status of expired has passed that date. The administrator can update the expiration date if they believe the content is still valuable. Expired content is still available but is only searched if explicitly selected during the search process.

The administrator periodically reviews each piece of content to decide whether to change its status in any way. If the content is not already tagged, the administrator adds the appropriate tags. If previously tagged, the tagging is reviewed to ensure its accuracy and to make changes if necessary. If the content is not already classified, the administrator classifies it. If previously classified, the administrator reviews the classification to ensure it=s accuracy and make changes if necessary. The content is then re-saved in the KM system.

With reference to FIG. 16, a researcher may create content that is intended for the KM system. The content may be newly created in which case it is classified according to the taxonomy hierarchy. All new content requires unique metadata and characteristics to be tagged and classified to the taxonomy for searchability and then is saved to the KM system for use.

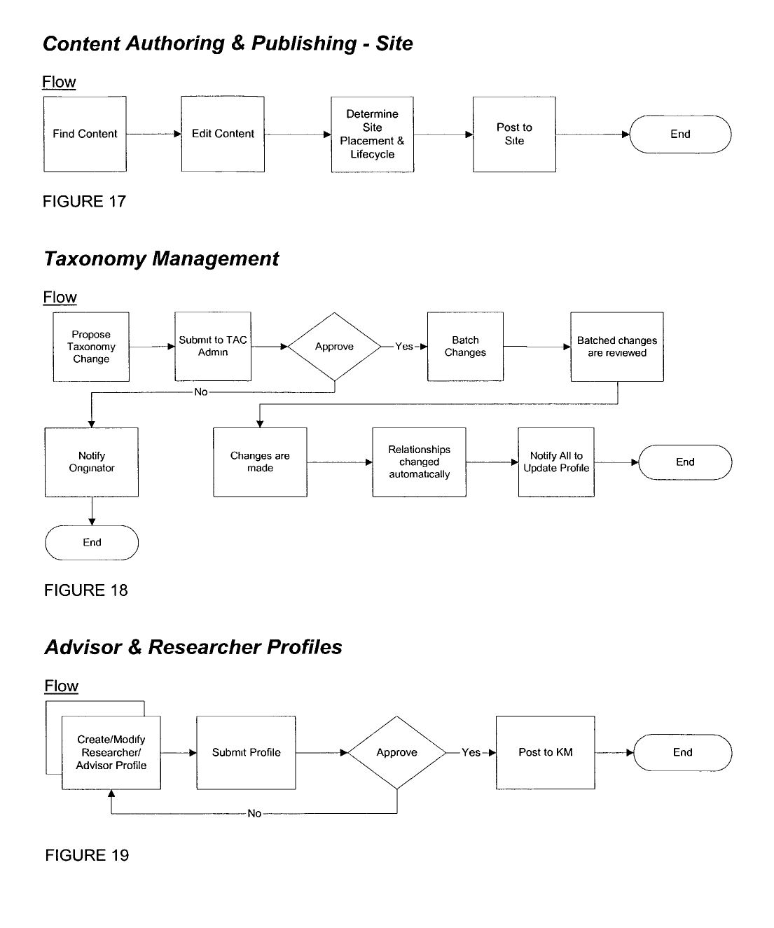

With reference to FIG. 17, content may be revised on the site. Relevant content is extracted from the KM system. The content may be the by-product of research processes or may be original content. The content is edited directly or annotated to add any summary information. The administrator determines where on the site the content belongs (i.e. Power Tips or Power Tools or somewhere else.) They also determine how long the content should remain on the site, setting an expiration date. The administrator then posts the content to the site.

With reference to FIG. 18, the search taxonomy is dynamic and evolves with changes or additions, and this must be managed. For example, someone may propose that a change be made to the taxonomy hierarchy. This could be a researcher, an advisor, or the administrator. The person proposing the change submits the proposal to the administrator.

The administrator decides whether the proposal is valid and may approve the change. If not, they notify the originator that the change has not been approved. If the administrator approves the changes, they compile the change request with any other changes that have been approved since the last time updates were made to the taxonomy. At times, there may be a change that is significant enough to warrant a change immediately. At other times, it is more practical to compile changes over a given time period and evaluate them as a whole. Then, any approved changes to taxonomy are implemented in a single update. Content items are reviewed and updated to reflect the new taxonomy.

The system also utilizes advisor and researcher profiles for administrative use and for searching for resources. Referring to FIG. 19, when a new researcher or advisor becomes affiliated with the system, they are provided access to the system. At their initial login, they are prompted to fill out a profile specifying their skill sets and other relevant information. The researcher/advisor profile is mapped to the taxonomy. Once activated, they may update their profile at any time. An active part of their profile may include their availability to work on specific projects.

The profile is submitted to the administrator for approval. If rejected, it is sent back to the advisor or researcher for modifications. If approved, it is posted to the KM system, and is available for assignment. The profile may appear in search results as a expert that can be consulted for assistance in responding to specific project requests.

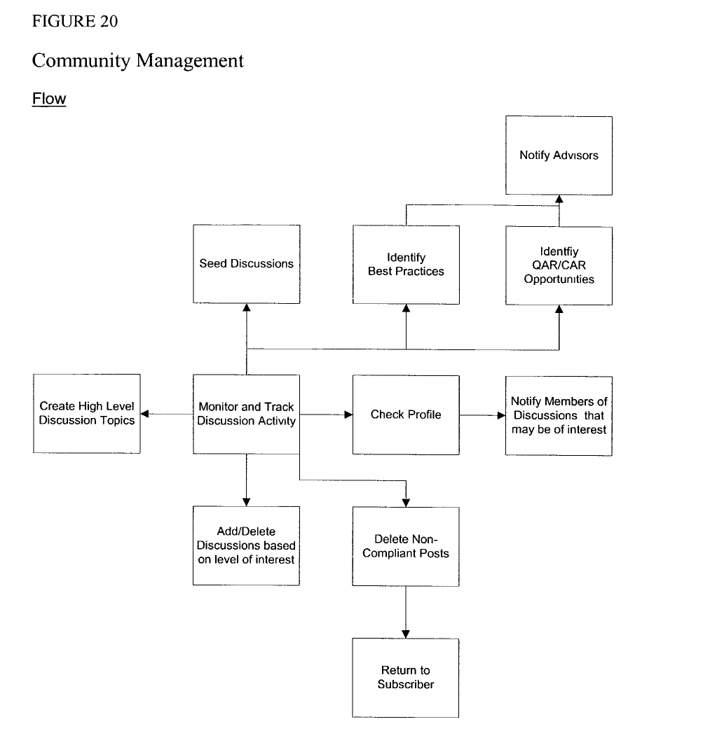

The advisory system is optionally used as a site for posting user questions or conducting a forum on topics of interest to the users. Referring to FIG. 20, the subscribers form a community, and interaction between subscribers may be useful to facilitate their business needs. Preferably, a community manager may create high-level discussion topics to stimulate interaction. The community manager monitors and tracks the activity within the discussions and adds discussion if a new topic is of interest. The community manager may delete a discussion topic that is producing no discussion. If a discussion has diverged into multiple threads, the community manager may extract threads and place them in a new topic, notifying participants.

It may be relevant for the community manager to seed discussion with their own questions or commentary, or respond to posted questions. The community manager may also identify posts that have the potential to be best practices. For topics, the community manager may identify activities that suggest the potential for a QAR or CAR, or query an advisor if they see any activity that suggests best practices or topics of value to the community. The community manager may review subscriber profiles to identify discussions of interest to subscribers, and notify subscribers of discussion that they may find of interest. If a subscriber posts material that is not in compliance with system guidelines, the community manager may delete the material, for return to the subscriber with an explanation of how the material failed to comply, and possibly with a suggestion as to how to make the material compliant.

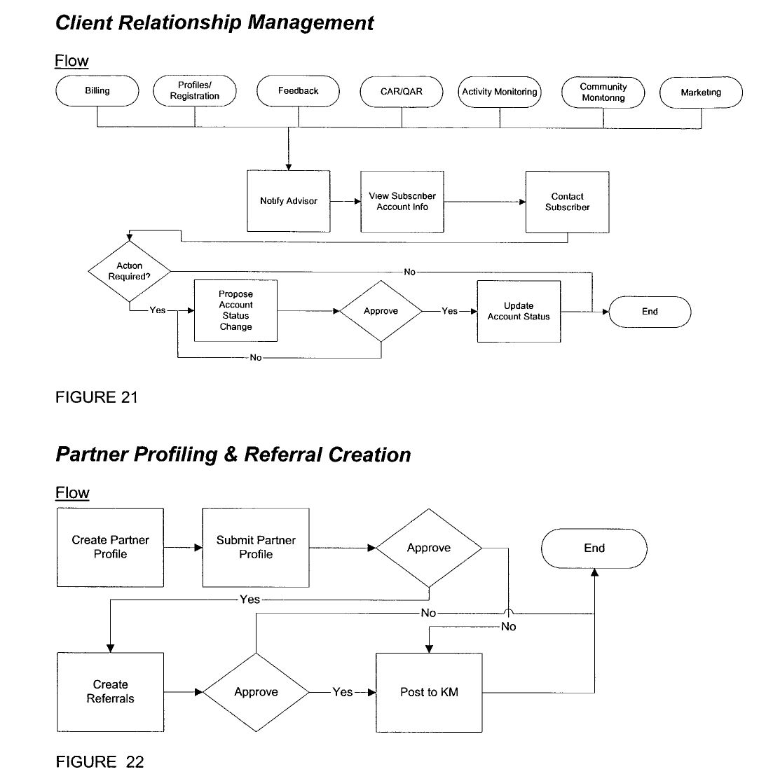

With reference to FIG. 21, a client relationship management process is initiated by one of the many processes described above, including billing, profiling, QAR/CAR, reporting, etc. Based on defined events—such as if a subscriber has had no activity in 3 months, or if they have had the subscription for 2 months and have not used a QAR, or if they are due for renewal in a month, etc—the system may notify the advisor that an event has occurred that requires a subscriber contact. The advisor checks the event and the subscriber account information as background to contacting the subscriber. The advisor contacts the subscriber and provides information or offers relevant to the event, such as advice on how to get more out of the service, a special offer on a QAR, etc. Based on the subscriber response, the advisor may take action to improve customer utilization or satisfaction such as an extension of the subscription or the provision of additional QARs, which the administrator may approve or disapprove.

With reference to FIG. 22, the system is envisioned to accept various partners as preferred providers of information or services on a referral basis. When this occurs, a partner profile is created, either directly by the partner on the site or via a phone interview by the administrator. The partner profile is submitted for review and approval. Once the profile is approved, a partner account is created and the partner can propose the type of work that they have the capability to complete on a referral basis. In such a case, a report generated by a researcher may include a recommendation or referral to the partner.

A specific referral enables more specific qualifying of partners. If a partner has skills for example in Win 2K migration in the financial services industry and Unix server consolidation in the engineering services industry, but not Win2K in the engineering services industry, creating specific referrals for the two viable options is required to prevent referring partners for services they have no experience providing. The referrals themselves are saved and are searched as well as the partner profiles.

A referral can be attached as specific content to a request, to facilitate the subscriber toward taking action. The system tracks referral outcome and subscriber satisfaction so that performance by specific partners for specific services can be tracked. As part of the review process, the advisor reviews and approves the partner for a specific referral. This does not prevent referring subscribers to the partner for other services, but enables researchers and advisors to more easily prioritize referrals. The referrals and the profile are posted for access in the KM system, as are disapproved profiles and referrals as these may be relevant for future reference.

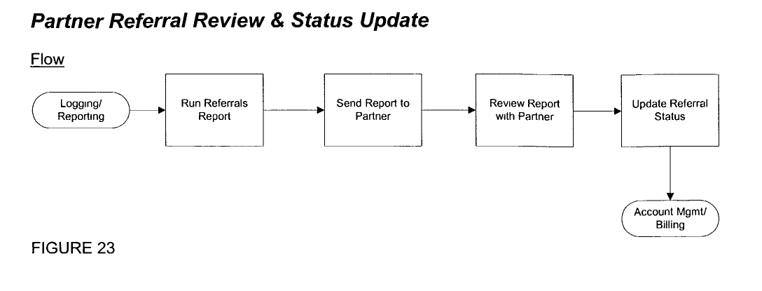

With reference to FIG. 23, partner referrals are periodically reviewed, generally initiated from the reporting system. The administrator runs a report that details pending referrals, and indicates which referrals are new. The administrator provides a copy of the report to the partner and reviews the report with the partner to determine the outcome of the referrals. The administrator marks whether there was a positive or negative outcome from the referral, and notes whether the partner should remain available for referral in the report. Referrals with a positive outcome may be identified in a separate billing report. Referrals with a negative outcome become part of the profile. If a partner receives significant negative ratings from subscribers, the system isolates the partner to prevent further referrals to this partner.

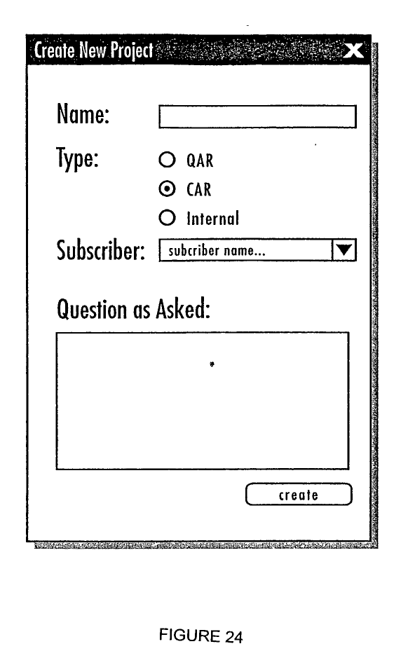

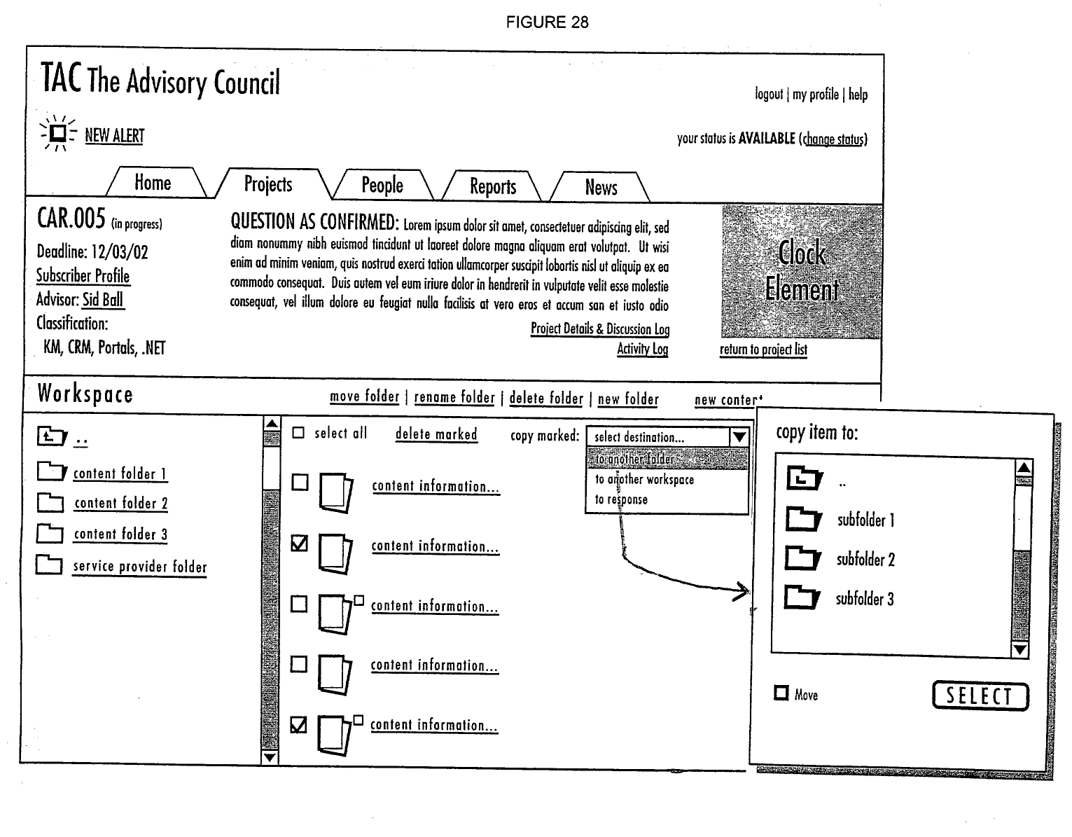

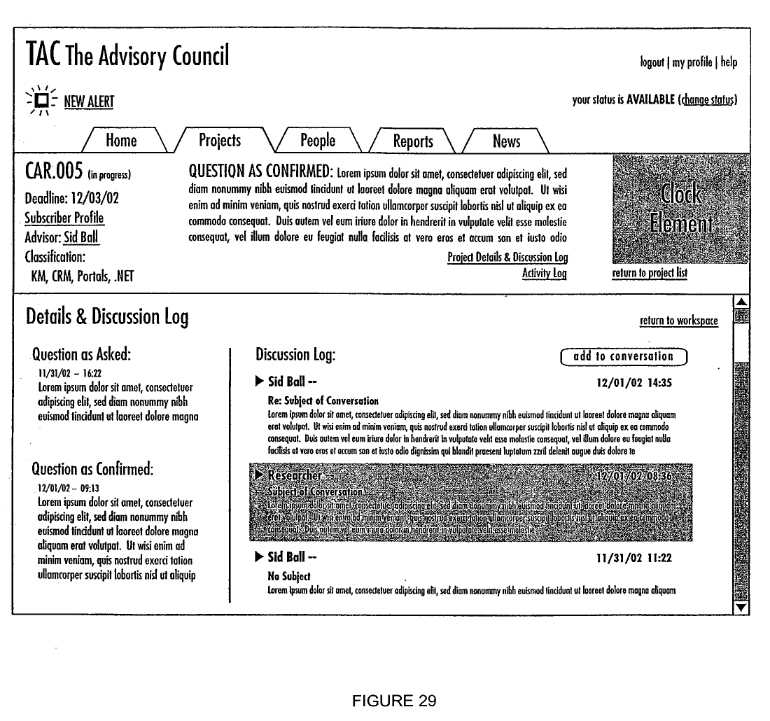

Referring to FIGS. 24-31, these are illustrative displays that may be used with the present invention, though of course the invention is not limited by these types of presentation, as many variations are possible. FIG. 24 is a view of a simple display that may be a pop-up, selected from the users' My Advice screen. The user selects the type of report required and posits a question. this is designated as “question as asked” so as to track the evolution of the question from its' initiation until confirmed after review for actual report generation, designated as “question as confirmed”.

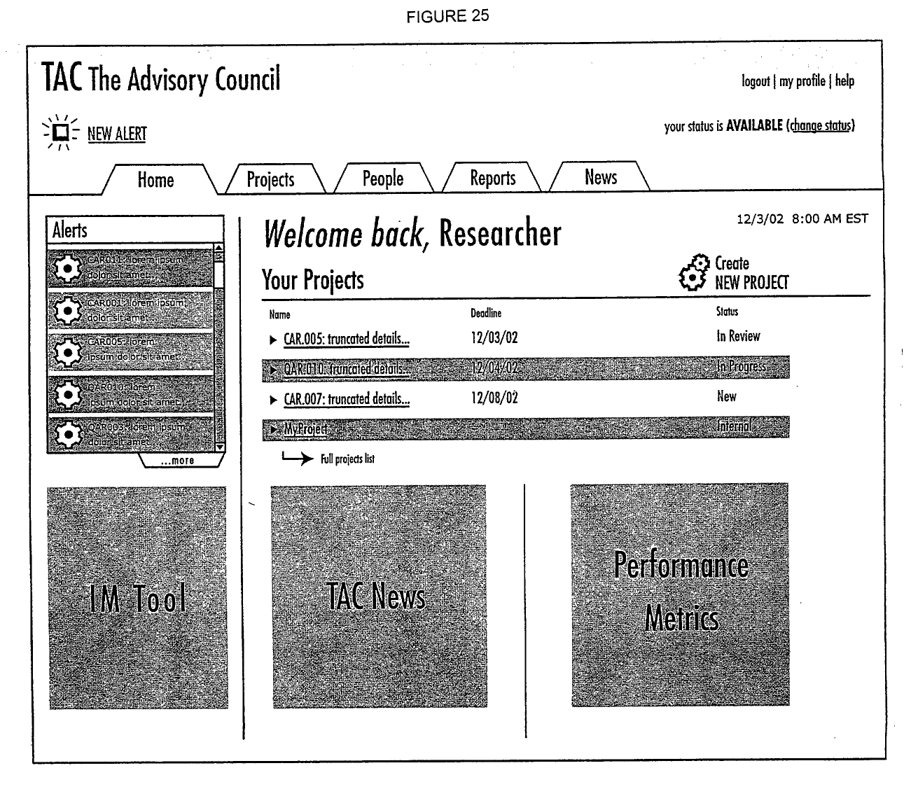

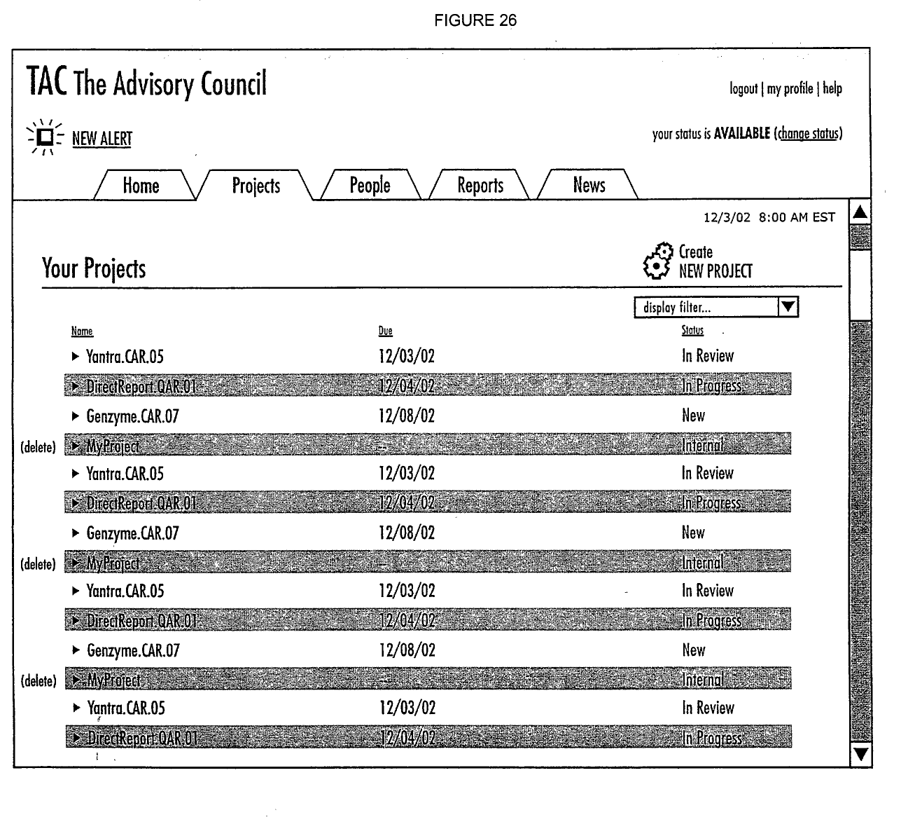

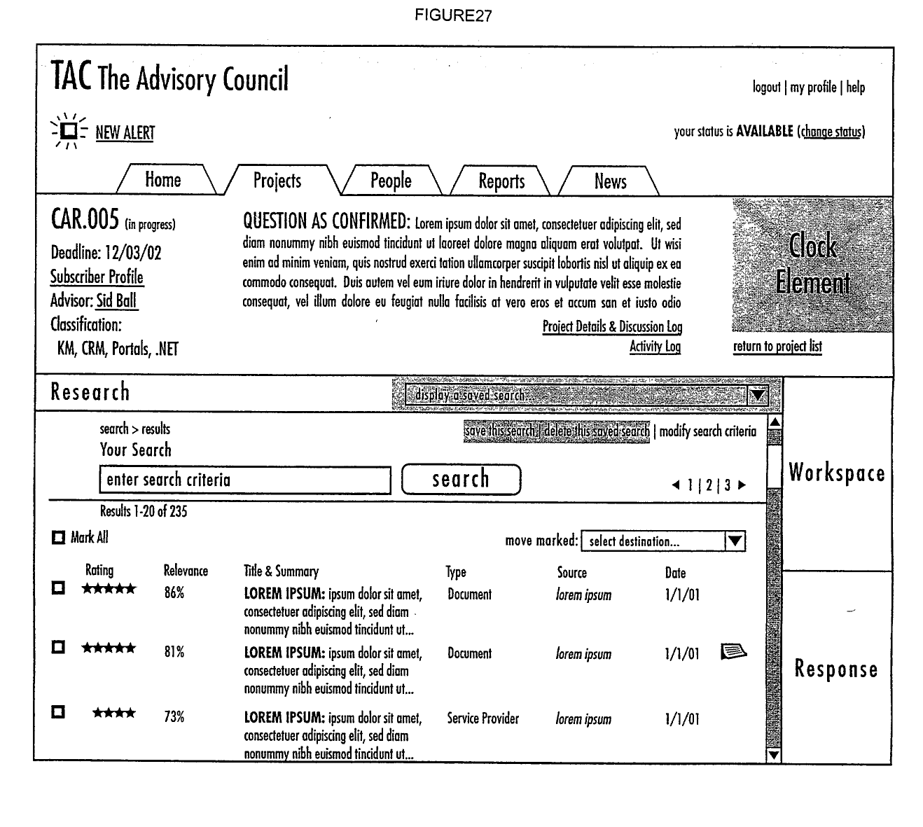

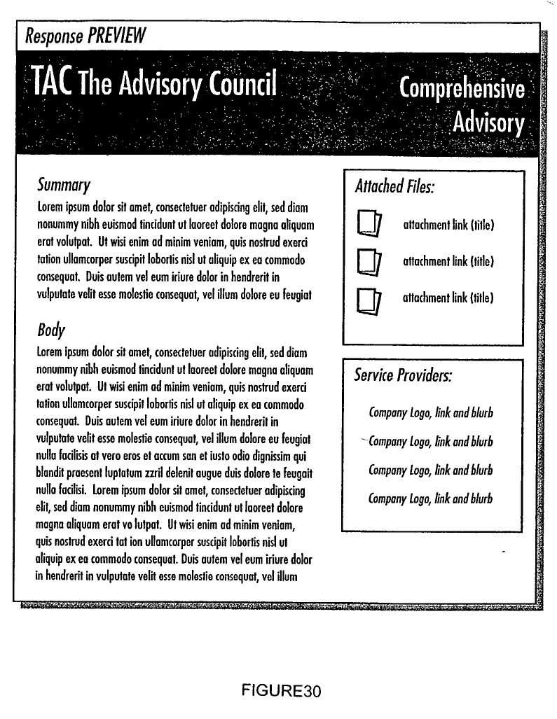

FIG. 25 is a display generated for a researcher, with tabs to different pages of the researchers' electronic work space. This lists the projects and resources available to the researcher. FIG. 26 is a detailed listing of projects and status, , with FIGS. 27-29 showing the search, results and discussion log associated with the project. On each working type of display, there is a clock element that shows elapsed time associated with the project, which may be cumulative but is more preferably a countdown to the time the response is due so the researcher can plan accordingly to complete the project on time. This is important, as timeliness of response is generally an important consideration for the user. In addition, the advisory system may generate email messages to the researcher, at certain selected times, as the deadline approaches, as reminders. FIG. 30 is an illustrative view of the displayed response as delivered to the user, showing links to content and possibly referrals to service providers.

Utilizing the present invention, small to large businesses have ready access to outside research and resources on an as needed basis, through a system accessible via the internet. Resources are qualified and analyzed to assure quality and timeliness of a targeted response to a query, in a cost effective manner.

We claim:

1. A computer based advisory system for generating advice for a user, the system comprising computer means having processing means, means for collecting, categorizing, synthesizing and disseminating requested information, and at least one database containing data on knowledge resources; means to receive a query from the user, means to analyze the query, means to search and select knowledge resources responsive to the query, means to engage the resources and to initiate generation of responsive advice; and, means to deliver the advice to the user.

2. The computer based advisory system of claim 1 further comprising means to locate and qualify knowledge resources for building the database.

3. The computer based advisory system of claim 1 further comprising means for monitoring progress in generation of the responsive advice.

4. The computer based advisory system of claim 1 further comprising means for reviewing the responsive advice prior to delivery and optionally means for revising the responsive advice prior to delivery to the user.

5. The computer based advisory system of claim 1 wherein the at least one database contains data selected from the group consisting of data on researchers, consultants, information providers, accumulated research material, user profiles, researcher profiles, accumulated responsive advice and published documents.

6. The computer based system of claim 1 further comprising means for an administrator to monitor the advice system operation.

7. The computer based advisory system of claim 1 further comprising means for assigning at least one advisor for interacting with the user.

8. The computer based advisory system of claim 1 wherein the computer means are accessible to the user via an internet connection.

9. The computer based system of claim 1 further comprising taxonomy means for classifying data in the database and for searching the data in the database.

10. The computer based system of claim 1 further comprising means for generating an electronic work space having one or more displays for use in generating the responsive advice.

11. A method for using a computer based system for generating advice for a user comprising:
providing a computer having processing means accessible by the user and having means for collecting, categorizing, synthesizing and disseminating information;
providing at least one database containing data on knowledge resources;
receiving a query from the user and analyzing the query;
searching the at least one database and selecting knowledge resources matched for responsiveness to the query;
engaging the knowledge resources and initiating generation of responsive advice; and,
delivering the responsive advice to the user.

12. The method of claim 11 further comprising locating and qualifying knowledge resources for building the database.

13. The method of claim 11 further comprising monitoring progress in generation of the responsive advice.

14. The method of claim 11 further comprising reviewing the responsive advice prior to delivery and optionally revising the responsive advice prior to delivery to the user.

15. The method of claim 11 wherein the at least one database contains data selected from the group consisting of data on researchers, consultants, information providers, accumulated research material, user profiles, researcher profiles, accumulated responsive advice and published documents.

16. The method of claim 11 further comprising providing an administrator to monitor generation of the responsive advice.

17. The method of claim 11 further comprising assigning at least one advisor for interacting with the user.

18. The method of claim 11 further comprising accessing the computer via an internet connection.

19. The method of claim 11 further comprising using a taxonomy for classifying data in the database and for searching the data in the database.

20. The method of claim 11 further comprising generating an electronic workspace having one or more displays for use in generating the responsive advice.
